(19) United States
(12) Patent Application Publication
(10) Pub. No.: US 2024/0301912 A1
(43) Pub. Date: Sep. 12, 2024

(54) SEAL WASHER

(71) Applicant: Aoyama Seisakusho CO.,LTD., Niwa-gun (JP)

(72) Inventor: Shinya WATANABE, Niwa-gun (JP)

(21) Appl. No.: 18/598,364

(22) Filed: Mar. 7, 2024

(30) Foreign Application Priority Data
Mar. 10, 2023 (JP) 2023-037016

(51) Int. Cl. F16B 43/00

(52) U.S. Cl. CPC F16B 43/001

(57) ABSTRACT

Provided is a seal washer that provides a good drop-off prevention effect for a bolt. A seal washer 1 has a flat ring-shaped washer body 2 formed by drilling a bolt insertion hole 14 and an inner water stop member 3 that is fixed around the bolt insertion hole 14 of the washer body 2. The inner water stop member 3 is thicker than the washer body 2 and made of an elastic material. A plurality of thin-walled anti-slip protrusions 8, 8 . . . are disposed on an inner peripheral surface of the inner water stop member 3 so as to protrude inwardly.

### CROSS-REFERENCE TO RELATED APPLICATION

This application claims priority from Japanese Patent Application No. 2023-037016 filed with the Japan Patent Office on Mar. 10, 2023, the entire content of which is hereby incorporated by reference.

### BACKGROUND

### 1. Technical Field

The present invention relates to a seal washer to be interposed between a bolt and a fastening body or a body to be fastened when the fastening body is screwed to the body to be fastened using the bolt to avoid leakage of liquid from a gap between them.

### 2. Related Art

An exterior component for a vehicle, such as a rear spoiler, is often fastened to a vehicle body using a fastener such as a bolt or the like through a bolt insertion hole drilled in the vehicle body. In order to keep rainwater or the like from entering an interior of the vehicle body from a boundary part between the exterior component to be fastened and the vehicle body via the bolt insertion hole (that is, to express a waterproof function), a washer with a sealing function (so-called seal washer) is sometimes interposed between an inner surface of the bolt head and the vehicle body.

As a conventional seal washer, as disclosed in JP-A-2021-116871, there has been known a seal washer in which an elastic member formed of an elastic material is disposed at an inner peripheral edge of an annular washer body made of metal so as to be thicker than the washer body. With such seal washer, when the bolt is fastened to a nut or the like, the elastic member is pressed against the inner surface of the bolt and the surface of the vehicle body and deformed to abut on the inner surface of the bolt and the surface of the vehicle body over a large area while holding high pressure, thus expressing a good waterproof function. In order to express the waterproof function, as disclosed in JP-A-5-39808, there is also a seal washer in which arc-shaped lip bodies having a constant width (amount of protrusion) are intermittently disposed on an inner peripheral surface of an elastic member fixed to a metal washer body such that they engage with a thread groove of a bolt.

However, the bolt may drop off from the washer in the seal washers disclosed in JP-A-2021-116871 and JP-A-5-39808 described above.

That is, the seal washers as disclosed in JP-A-2021-116871 and JP-A-5-39808 described above are used in a state in which they are incorporated into the bolt before fastening to improve work efficiency at the time of fastening in some cases.

In such cases, in order to avoid dropping off of the seal washer after the bolt is incorporated and before fastening, the seal washer is designed such that the insertion hole of the seal washer has a diameter slightly smaller than an outer peripheral surface of a shaft portion of the bolt, and the bolt is fit together by insertion.

However, due to a variation in the outer peripheral surface of the shaft portion of the bolt and a variation in an inner diameter size of the seal washer, or when the seal washer itself is heavy in weight, the weight of the seal washer cannot be supported only by the retention by fitting, and the seal washer may drop off from the bolt. This is likely to occur especially during transportation between factories or the like after manufacturing or during conveyance at the time of attachment to a product.

To counter this situation, measures are taken such as designing the insertion hole of the seal washer with a small diameter or disposing a protrusion for drop-off prevention inside the seal washer. However, when a fitting force is simply increased, an insertion load of the bolt is increased and the work efficiency is decreased.

In addition, the metal washer body and a seal portion made of resin may separate from each other due to friction during fitting by insertion.

It is an object of the present invention to solve the above-described problem in the conventional seal washer and provide a seal washer that provides a good drop-off prevention effect for the bolt.

### SUMMARY

In the present invention, an invention described in claim 1 is a seal washer to be interposed between a bolt and a fastening body or a body to be fastened when the fastening body is screwed to the body to be fastened using the bolt to avoid leakage of liquid from a gap between the bolt and the fastening body and/or the body to be fastened. The seal washer includes a flat ring-shaped washer body formed by drilling a bolt insertion hole and an inner water stop member made of an elastic material that is fixed around the bolt insertion hole of the washer body. An anti-slip protrusion is disposed on the inner water stop member (such as on an inner peripheral surface of the inner water stop member) so as to protrude inwardly. The anti-slip protrusion can be disposed integrally with the inner water stop member or can be disposed on the inner water stop member using a method such as bonding, welding, or fusing.

The seal washer according to claim 1 configured as described above can provide a good drop-off prevention effect for the bolt since the anti-slip protrusion of the inner water stop member acts like a check valve against a threaded surface of the bolt. That is, the effect of avoiding complete loosening of screwing when the screw strength is inadvertently reduced, and maintaining the water stop function in that state can be expected.

The invention described in claim 2 is the invention described in claim 1 in which a planar shape of the anti-slip protrusion is tongue-shaped (that is, each of the anti-slip protrusions has a rectangular body, a trapezoidal body, a triangular body, a semi-circular body, a semi-elliptical body or the like whose width is narrower at a distal end edge than at a base end edge).

The seal washer according to claim 2 configured as described above can avoid dropping off of the bolt with higher accuracy over a long period of time since each of the anti-slip protrusions is easily bent in an insertion direction of the bolt and is difficult to be torn off when the bolt is inserted into the bolt insertion hole. It is more preferable that the width of the anti-slip protrusion is adjusted in a range of 0.5 mm to 2.0 mm with respect to the amount of inward protrusion.

The invention described in claim 3 is the invention described in claim 1 in which a distal end of the anti-slip protrusion is located inside an outer peripheral surface of a shaft portion of a bolt that is fastened to the body to be fastened.

The seal washer according to claim 3 configured as described above can extremely effectively avoid dropping off of the bolt since each of the anti-slip protrusions is bent more easily. It is more preferable that each of the anti-slip protrusions is configured such that a distal end of the anti-slip protrusion is located 0.5 mm to 1.5 mm inward from the threaded surface of the shaft portion of the bolt.

The invention described in claim 4 is the invention described in claim 1 in which an outer water stop member made of an elastic material is disposed at an outer peripheral edge of the washer body.

The seal washer according to claim 4 configured as described above can provide extremely high waterproof performance since the outer water stop member and the inner water stop member abut on an outer surface of the fastening body (or body to be fastened) and an inner surface of a head portion of the bolt to form a double waterproof wall. In the event that the inner water stop member made of the elastic material is peeled off from the metal washer body due to repeated use or the like, the outer water stop member can retain the waterproof function.

### BRIEF DESCRIPTION OF DRAWINGS

FIGS. 1A to 1C are explanatory views illustrating a seal washer (FIG. 1A is a plan view, FIG. 1B is a front view, and FIG. 1C is an end view taken along the line α-α in FIG. 1A);

FIGS. 2A and 2B are explanatory views illustrating a part where an anti-slip protrusion of an inner water stop member of the seal washer is provided (FIG. 2A is an enlarged view of a part 7 in FIG. 1C, and FIG. 2B is an enlarged view of a part β in FIG. 1A);

FIGS. 3A to 3C are explanatory views illustrating a method for using the seal washer (FIG. 3A shows a state before inserting a bolt, FIG. 3B shows a state after inserting the bolt, and FIG. 3C is an enlarged view of a part δ in FIG. 3B); and

FIGS. 4A and 4B are explanatory views illustrating a modification of the seal washer (FIG. 4A is a plan view, and FIG. 4B is a cross-sectional view taken along the line ε-ε in FIG. 4A).

### DETAILED DESCRIPTION

The following describes one embodiment of a seal washer according to the present invention in detail based on the drawings.

### <Structure of Seal Washer>

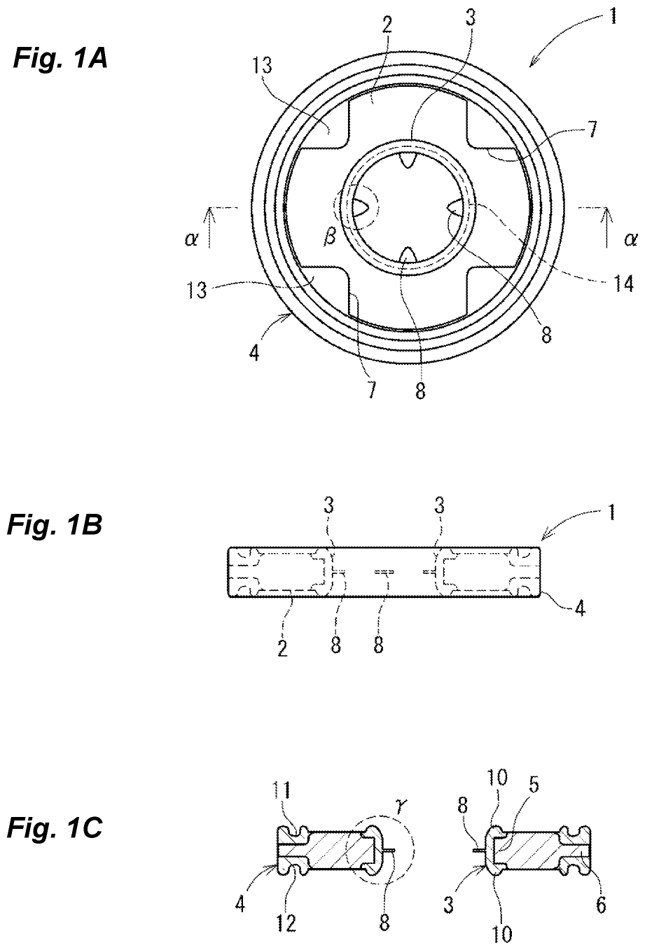

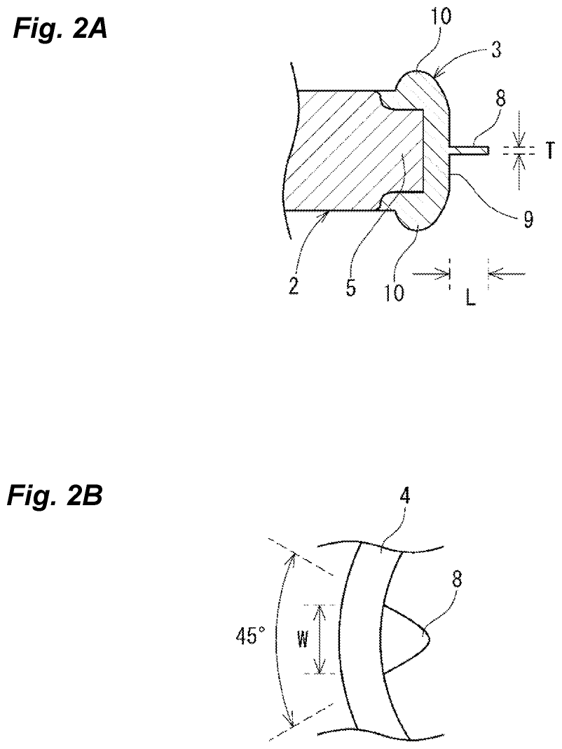

FIGS. 1A to 1C, FIGS. 2A and 2B show a seal washer 1, and the seal washer 1 has an inner water stop member 3 and an outer water stop member 4 made of synthetic resin (olefinic elastomer) fixed to an inner peripheral edge and an outer peripheral edge, respectively, of a washer body 2 made of metal (iron). The seal washer 1 is formed integrally by injecting molten synthetic resin (that is, olefinic elastomer, which is a material for forming the inner water stop member 3 and the outer water stop member 4) into a mold in which the washer body 2 is disposed, using the insert molding method.

The washer body 2 is formed in a shape of a doughnut plate having a constant thickness. That is, the washer body 2 is formed in a disc shape with a circular bolt insertion hole 14 of a predetermined diameter (approximately 6 mmφ) drilled in the center. An upper surface and a lower surface at an inner peripheral edge of the washer body 2 are provided with circumferential depressed portions having a constant width and a constant depth, forming an inner thin portion 5. An upper surface and a lower surface of an outer peripheral edge of the washer body 2 are also provided with circumferential depressed portions having a constant width and a constant depth, forming an outer thin portion 6. The inner thin portion 5 is formed to be thicker than the outer thin portion 6. In addition, on the upper surface and the lower surface of the outer peripheral edge of the washer body 2, depressed portions 7, 7 . . . that are approximately triangular-shaped in plan view are formed.

The inner water stop member 3 is formed in an annular shape with an approximately U-shape in a vertical cross section so as to sandwich the inner thin portion 5 of the washer body 2 from above and below, and upper and lower outer distal end parts enter the depressed-shaped parts of the upper surface and the lower surface of the inner peripheral edge of the washer body 2, respectively. The parts entering the upper and lower depressed-shaped parts bulge in the vertical direction to form bulging parts 10, 10. FIG. 2A shows an enlarged view of a part where the inner water stop member 3 is provided. An inner part of the inner water stop member 3 is thick-walled with a predetermined thickness (approximately 0.5 mm) at a part located inside the inner thin portion 5 of the washer body 2, forming a constant thickness part 9. The top and bottom of the constant thickness part 9 have an outwardly convex curved surface so as to be continuous with the upper and lower bulging parts 10, 10.

In the center (center in the vertical direction) of an inner peripheral surface of the inner water stop member 3, four anti-slip protrusions 8, 8 . . . that are approximately tongue-shaped in plan view are provided such that they protrude inwardly at regular intervals (equiangularly) with respect to the axis center of the washer body 2. FIG. 2B shows a part where the anti-slip protrusion 8 is provided. Each of the anti-slip protrusions 8, 8 . . . is formed in an approximately triangular shape with a rounded distal end (R-shaped) in plan view and has a constant thickness (T=0.2 mm). The anti-slip protrusion 8 protrudes inwardly from the inner peripheral surface of the inner water stop member 3 by a predetermined length (L=1.0 mm). In addition, each of the anti-slip protrusions 8, 8 . . . has right and left end edges that form an angle of approximately 450 and has a base end part with a predetermined width (approximately 1.5 mm).

On the other hand, the outer water stop member 4 is formed in an annular shape with an approximately U-shape in a vertical cross section so as to sandwich the outer thin portion 6 of the washer body 2 from above and below, and upper and lower outer distal end parts enter the depressed-shaped parts of the upper surface and the lower surface of the outer peripheral edge of the washer body 2, respectively. Furthermore, upper and lower outer end edge parts and inner end edge parts are bulged in the vertical direction (bulged to the same amount of protrusion from a surface of the washer body 2), and an upper circumferential depressed portion 11 and a lower circumferential depressed portion 12 are each formed between the bulging parts. The amount of bulging (the amount of protrusion from the surface of the washer body 2) of the bulging parts inside and outside the upper circumferential depressed portion 11 and the amount of bulging of the bulging parts inside and outside the lower circumferential depressed portion 12 are the same as the amount of bulging of the upper and lower bulging parts 10, 10 of the inner water stop member 3.

A part of the outer water stop member 4 located outside the outer thin portion 6 of the washer body 2 is thin-walled with a predetermined thickness (approximately 0.5 mm). Furthermore, four inflow portions 13, 13 . . . having an approximately triangular shape in plan view are disposed consecutively at regular intervals at an inner peripheral edge of an upper surface of the outer water stop member 4, entering into the depressed portions 7, 7 . . . formed in an upper surface of the washer body 2.

### <Method for Using Seal Washer (Operation)>

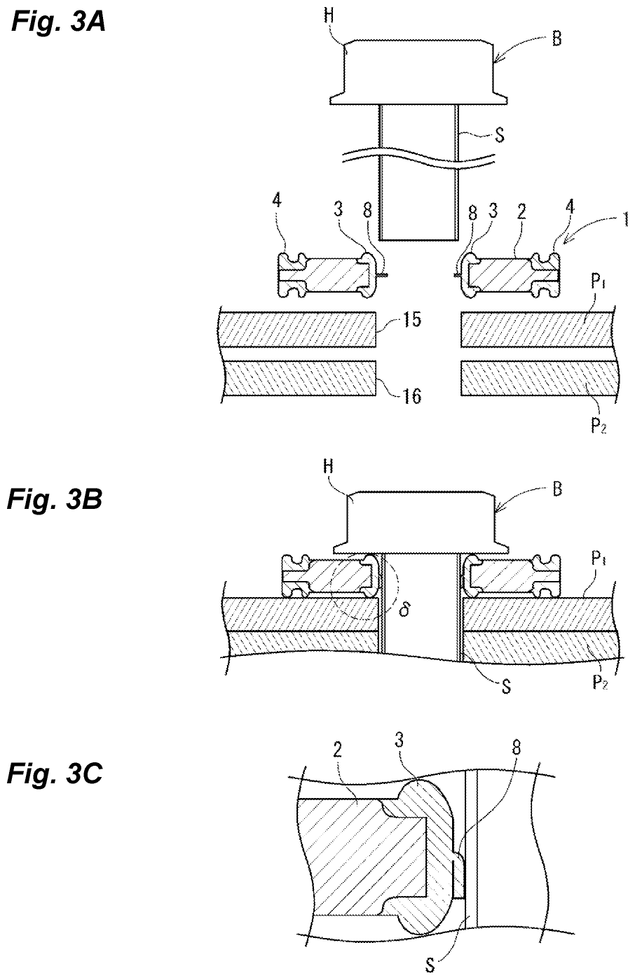

FIGS. 3A to 3C show an exemplary mode of use of the seal washer 1 configured as described above. The seal washer 1 is interposed between a fastening body P₁ (or body P₂ to be fastened) and a bolt B (or nut) when fastening the fastening body P₁ to the body P₂ to be fastened using the bolt B (4.5 mmφ) and the nut (not shown) for the purpose of, for example, avoiding leakage of liquid (such as rainwater) or the like from a gap between a bolt insertion hole 15 of the fastening body P₁ and a bolt insertion hole 16 of the body P₂ to be fastened and a threaded surface S of the bolt B.

It is needless to say that the bolt B here may be any fastening member having a male threaded portion on its shaft portion, such as a tapping screw, in addition to an ordinary bolt.

FIG. 3A shows a state before inserting the bolt B into the bolt insertion hole 14 of the seal washer 1. In this state, each of the anti-slip protrusions 8, 8 . . . on the inner peripheral surface of the inner water stop member 3 of the seal washer 1 protrudes inwardly and forms an identical horizontal surface.

When the bolt B is inserted into the bolt insertion hole 14 of the seal washer 1, as shown in FIG. 3B, each of the elastic anti-slip protrusions 8, 8 . . . on the inner peripheral surface of the inner water stop member 3 is bent downwardly in a narrow gap between the bolt insertion hole 14 of the seal washer 1 and the threaded surface S of the bolt B, and an upper surface of each of the anti-slip protrusions 8, 8 . . . abuts on the threaded surface S of the bolt B over a wide area. Each of the anti-slip protrusions 8, 8 . . . thus bent downwardly in the narrow gap has no influence when moving in a direction in which the bolt B is screwed (downward in FIGS. 3A to 3C), but expresses an extremely high frictional resistance force and effectively suppresses loosening of the bolt B when moving in a direction in which the bolt B is loosened (upward in FIGS. 3A to 3C).

### <Effect of Seal Washer>

As described above, the seal washer 1 has a flat ring-shaped washer body 2 formed by drilling the bolt insertion hole 14 and the inner water stop member 3 that is fixed around the bolt insertion hole 14 of the washer body 2. The inner water stop member 3 is thicker (has a thicker part) than the washer body 2 and made of an elastic material. A plurality of thin-walled anti-slip protrusions 8, 8 . . . are disposed on the inner peripheral surface of the inner water stop member 3 so as to protrude inwardly.

In the seal washer 1, the anti-slip protrusions 8, 8, . . . on the inner peripheral surface of the inner water stop member 3 abut on a peripheral surface of a screw portion of the bolt B (threaded surface S) over a wide area and act like a check valve, thus they can be expected to provide a good drop-off prevention effect for the bolt B.

At the time of fastening the seal washer 1, since a planar shape of each of the anti-slip protrusions 8, 8 . . . is tongue-shaped and each of the anti-slip protrusions 8, 8 . . . is easily bent in an insertion direction of the bolt B and is difficult to be torn off when the bolt B is inserted into the bolt insertion hole 14, it can be expected to avoid dropping off of the bolt B with higher accuracy over a long period of time.

Furthermore, in the seal washer 1, the distal end of each of the anti-slip protrusions 8, 8 . . . is located inside by a predetermined length from the threaded surface S of the bolt B that screws the fastening body P₁ and the body P₂ to be fastened (that is, the distal end of each of the anti-slip protrusions 8, 8 . . . is located inside by 0.75 mm from the threaded surface S of the bolt B), thus each of the anti-slip protrusions 8, 8 . . . is more easily bent. Therefore, dropping off of the bolt B can be avoided extremely effectively. That is, the effect of avoiding complete loosening of screwing when the screw strength is inadvertently reduced, and maintaining the water stop function in that state can be expected.

### <Modifications of Seal Washer>

The seal washer according to the present invention is not limited to the aspect of the above-described embodiment at all, and the configuration of material, shape, structure, size, or the like can be appropriately changed as necessary without departing from the gist of the present invention.

For example, the seal washer according to the present invention is not limited to the one in which the four anti-slip protrusions are disposed at regular intervals on the inner peripheral surface of the inner water stop member as described in the above embodiment, and may be one in which one to three anti-slip protrusions are disposed on the inner peripheral surface of the inner water stop member, may be one in which five or more anti-slip protrusions are disposed on the inner peripheral surface of the inner water stop member, or may be one in which a plurality of anti-slip protrusions are disposed at irregular intervals on the inner peripheral surface of the inner water stop member.

The seal washer according to the present invention is not limited to the one in which the washer body is formed of iron as described in the above embodiment, and may be one in which the washer body is formed of stainless steel, copper, aluminum, hard plastic, ceramics, or the like. The seal washer is not limited to the one having a flat surface, and may be one in which the surface is subjected to matting process (surface roughening process) or the like to improve adhesiveness to the inner water stop member and the outer water stop member.

Furthermore, the seal washer according to the present invention is not limited to the one in which the inner water stop member and the outer water stop member are formed of olefinic elastomer as described in the above embodiment, and may be one in which the inner water stop member and the outer water stop member are formed of any synthetic resins (having elasticity) including isoprene rubber, butadiene rubber, styrene-butadiene rubber, chloroprene rubber, nitrile rubber, butyl rubber, ethylene propylene rubber, acrylic rubber, epichlorohydrin rubber, urethane rubber, silicone rubber, a mixture or modified product of one or more thereof, or the like, and the material can be changed as necessary depending on needs such as adhesiveness to the constituent material of the seal washer.

Furthermore, the seal washer according to the present invention is not limited to the one in which the anti-slip protrusion of the inner water stop member is tongue-shaped, such as an approximately triangular shape, with a rounded distal end in plan view, as described in the above embodiment, and can also be changed to one in which the anti-slip protrusion is a wide (wide along the inner peripheral surface of the inner water stop member) strip-shaped or one in which the anti-slip protrusion has a rectangular shape, or the like. When the shape of the anti-slip protrusion is approximately triangular-shaped (tongue-shaped) with a rounded distal end in plan view as described in the above embodiment, the anti-slip protrusion is difficult to be torn from the inner peripheral surface of the inner water stop member, and thus the seal washer provides the drop-off prevention effect for the bolt over a long period of time.

The thickness and size of the anti-slip protrusion of the inner water stop member can be changed as necessary depending on the material of the inner water stop member or the like. When the material for forming the inner water stop member is olefinic elastomer, as described in the above embodiment, adjusting the thickness of the anti-slip protrusion to 0.1 mm to 0.5 mm is preferable since the anti-slip protrusion expresses appropriate elasticity and flexibility, and thus the drop-off prevention effect for the bolt is further improved. As described in the above embodiment, adjusting the shape of the anti-slip protrusion such that an angle between both right and left end edges of the anti-slip protrusion and the inner peripheral surface of the inner water stop member is an obtuse angle is particularly preferable since the anti-slip protrusion is extremely difficult to be torn from the inner peripheral surface of the inner water stop member.

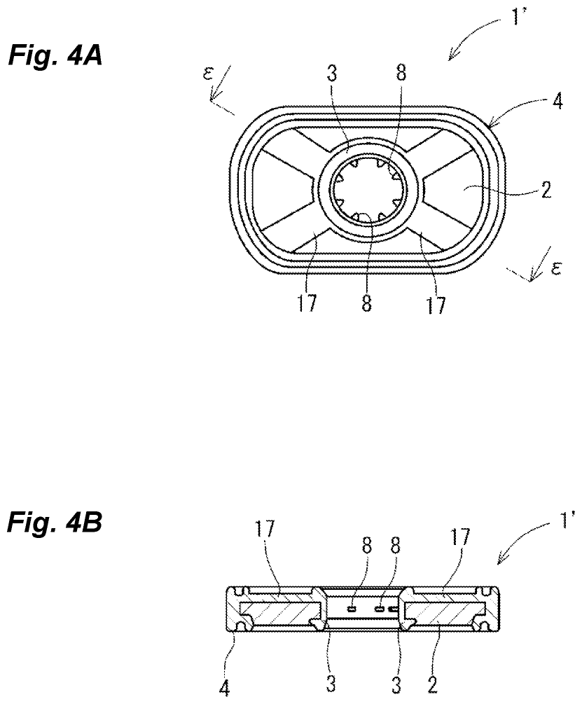

In addition, the seal washer according to the present invention is not limited to the one in which the washer body has an annular shape (doughnut shape with a circular outer peripheral edge) as described in the above embodiment, and may be one in which the outer peripheral edge has an elliptical shape as shown in FIGS. 4A and 4B or one in which the outer peripheral edge has a rectangular shape. In addition, the seal washer according to the present invention is not limited to the one in which the inner water stop member and the outer water stop member are separated as described in the above embodiment, and may be one in which the inner water stop member and the outer water stop member are coupled by a coupling body or the like as shown in FIGS. 4A and 4B. When such a configuration is adopted, there is an advantage that the inner water stop member and the outer water stop member are more difficult to be peeled off from the washer body.

### INDUSTRIAL APPLICABILITY

The seal washer according to the present invention provides the excellent effects as described above, and therefore, can be appropriately used as a member to avoid leakage of liquid from the gap between the bolt and the fastening body or the body to be fastened when fastening the fastening body and the body to be fastened.

### DESCRIPTION OF REFERENCE SIGNS

1, 1′ . . . Seal washer, 2 . . . Washer body, 3 . . . Inner water stop member, 4 . . . Outer water stop member, 5 . . . Inner thin portion, 6 . . . Outer thin portion, 7 . . . Depressed portion, 8 . . . Anti-slip protrusion, 9 . . . Constant thickness part, 10 . . . Bulging part, 11 . . . Upper circumferential depressed portion, 12 . . . Lower circumferential depressed portion, 13 . . . Inflow portion, 14 . . . Bolt insertion hole (washer body), 15 . . . Bolt insertion hole (fastening body), 16 . . . Bolt insertion hole (body to be fastened), 17 . . . Coupling body, B . . . Bolt, P₁ . . . Fastening body, P₂ . . . Body to be fastened, S . . . Threaded surface

What is claimed is:

1. A seal washer to be interposed between a bolt and a fastening body or a body to be fastened when the fastening body is screwed to the body to be fastened using the bolt to avoid leakage of liquid from a gap between the bolt and the fastening body and/or the body to be fastened, the seal washer comprising:
a flat ring-shaped washer body formed by drilling a bolt insertion hole; and
an inner water stop member made of an elastic material that is fixed around the bolt insertion hole of the washer body, wherein
an anti-slip protrusion is disposed on the inner water stop member so as to protrude inwardly.

2. The seal washer according to claim 1, wherein
a planar shape of the anti-slip protrusion is tongue-shaped.

3. The seal washer according to claim 1, wherein
a distal end of the anti-slip protrusion is located inside an outer peripheral surface of a shaft portion of a bolt that is fastened to the body to be fastened.

4. The seal washer according to claim 1, wherein
an outer water stop member made of an elastic material is disposed at an outer peripheral edge of the washer body.
